(19) United States
(12) Patent Application Publication
(10) Pub. No.: US 2015/0120874 A1
(43) Pub. Date: Apr. 30, 2015

(54) SERVER SYSTEM AND STORAGE SYSTEM

(71) Applicant: Samsung Electronics Co., Ltd, Suwon-si (KR)

(72) Inventors: Jae-nyeong KIM, Suwon-si (KR); Sang-bin LEE, Suwon-si (KR)

(73) Assignee: Samsung Electronics Co., Ltd, Suwon-si (KR)

(21) Appl. No.: 14/247,448

(22) Filed: Apr. 8, 2014

(30) Foreign Application Priority Data
Oct. 25, 2013 (KR) 10-2013-0127673

(51) Int. Cl. H04L 29/08

(52) U.S. Cl. CPC H04L 67/1097
USPC 709/218

(57) ABSTRACT

A storage system includes a communicator configured to perform communication with the plurality of servers, a storage having a plurality of storage media using a preset communication interface, and an I/O controller configured to transmit and receive data between the plurality of storage media and the plurality of servers in accordance with a mapping table which divides the plurality of storage media into a plurality of regions and stores information of the servers that correspond to the plurality of regions.

### CROSS-REFERENCE TO RELATED APPLICATIONS

This application claims priority under 35 U.S.C. §119(a) to Korean Patent Application No. 10-2013-0127673 filed on Oct. 25, 2013, in the Korean Intellectual Property Office, the disclosure of which is incorporated herein by reference.

### BACKGROUND OF THE INVENTION

1. Field of the Invention

The present disclosure relates to a server system and a storage system, and more particularly, to a server system and a storage system, which can directly connect the storage system and a micro server to each other using a PCI express interface.

2. Description of the Related Art

Recently, with the development of high-speed internet and intranet, a server technology that can process large-capacity data at high speed has been in need. Accordingly, a rack mount type cluster server technology has been developed. However, this type server has problems in that its size is large and power consumption is greatly increased, and system extension is limited since respective server modules should be connected by cables.

Accordingly, a micro server using a processor module has recently been used. The processor module refers to a thin modularized extension server in which rack servers are not horizontally piled up like a rack mount type server, but are inserted into a main body of a micro server system to be operated. The micro server is also called a high-density server since a large number of servers can be inserted and installed in a narrow space. The micro server includes built-in core elements, such as at least one CPU (Central Processing Unit), a storage device, and an operating system, and functions as a server which is supported with various types of control functions, such as power supply, input/output, and accompanying devices, from the main body.

On the other hand, recent trends show that servers use storage spaces of an external storage system rather than self-storage spaces. In this respect, a storage system that can store data at high density has been required.

In the related art, however, a storage system is implemented using NAS (Network Attach Storage), DAS (Direct Attached Storage), and SAN (Storage Area Network) technologies, which have the following disadvantages.

First, the NAS is a storage system which has a separate operating system and is connected via an Ethernet method. Since the NAS uses Ethernet as an interface, Ethernet traffic may occur, sharing block types is not possible, and it is necessary to separately configure individual storage spaces in a server.

The DAS is a system in which a server is connected to a storage interface of a large-capacity storage medium. However, connection of plural servers to the DAS is restricted, and the DAS can be used only as a small-scale independent configuration.

The SAN is a system that is connected through a storage-dedicated network switch. Since the SAN is provided with separate storage channels, it has good extensibility and flexibility, but has problems that additional costs (equipment/power/space) for optical channels and optical switches occur.

In the related art as described above, in order for plural servers to access the storage, the Ethernet, FC (Fiber Channel), or switches are required, and due to the structural problems, cost increase and restrictions in low power/high integration occur. Further, the performance of the storage, such as a response speed, is deteriorated as result of passing through several stages.

### SUMMARY OF THE INVENTION

The present disclosure addresses at least the above problems and/or disadvantages and also provides at least the advantages described below. Accordingly, the present disclosure provides a server system and a storage system, which can directly connect the storage system and a micro server to each other using a PCI express interface.

Additional features and utilities of the present general inventive concept will be set forth in part in the description which follows and, in part, will be obvious from the description, or may be learned by practice of the general inventive concept.

Exemplary embodiments of the present disclosure provide a storage system that is connectable to a plurality of servers including a common interface bus, the storage system including: a communicator configured to perform communication with the plurality of servers; a storage having a plurality of storage media using a preset communication interface; and an I/O (Input/Output) controller configured to transmit and receive data between the plurality of storage media and the plurality of servers in accordance with a mapping table which divides the plurality of storage media into a plurality of regions and stores information of the servers that correspond to the plurality of regions.

The plurality of storage media may be divided into a private region in which an operating system of the specific server is stored and a virtual region which is commonly used by the plurality of servers.

The I/O controller may transmit/receive data with respect to the server through the common interface bus and may transmit/receive the transmitted/received data through the communication interface that is used by the storage and the storage media.

The I/O controller may convert a signal that is received through the common interface bus to correspond to the preset communication interface and may convert a signal that is received through the storage media to correspond to the common interface bus.

The common interface bus may be a PCI express interface bus.

The interface bus may be at least one of SAS (Serial Attached SCSI), SATA (Serial ATA), and NVMe (Non Volatile Memory express).

The I/O controller may adjust bandwidths of the servers in accordance with the number of channels of the servers.

The storage system according to the aspect of the present disclosure may further include a switch configured to selectively connect the I/O controller and the plurality of servers to each other.

The switch may include a PCI express switch circuit and may selectively adjust a connection relationship between a plurality of processor modules and at least one I/O card.

The I/O controller may adjust bandwidths between the plurality of servers.

The I/O controller may support hot swap with respect to the plurality of storage media.

The I/O controller may perform replication of the data and may store replicated data in the plurality of storage media.

The I/O controller may perform de-emphasis process with respect to a signal that is transmitted to the storage medium or the server and may perform equalizer process with respect to a signal that is received from the storage medium or the server.

The storage medium may be a HDD (Hard Disk Drive) or a SSD (Solid State Disk).

The I/O controller may make the plurality of storage media be sequentially driven at an initial driving of the storage system.

The I/O controller may include a memory configured to temporarily store data between the server and the storage medium.

The storage system according to an exemplary embodiment of the present disclosure may further include a BMC (Baseband Management Controller) configured to sense status information of the storage system and to provide an IPMI (Intelligent Platform Management Interface) service so that an external management server can perform remote control of the storage system.

The BMC may control the I/O controller to allocate a disk to the server if a disk allocation request for the server is received from an external management server.

The BMC may control the I/O controller to receive management information from the storage media and to perform disk allocation based on the received management information.

Examplary embodiments of the present disclosure also provide a server system including: a server including a common interface bus and a plurality of processor modules; and a storage system including a plurality of storage media and an I/O controller configured to provide data that is stored in the plurality of storage media to the server, wherein the storage system transmits or receives the data with respect to the server through the common interface bus.

Exemplary embodiments of the present disclosure also provide a storage system connectable to a plurality of servers, comprising: a storage including a plurality of storage media; an I/O controller to transmit/receive data with the servers and to transmit/receive the transmitted/received data with corresponding ones of the storage media; and a switch to selectively connect the I/O controller with the plurality of servers.

In an exemplary embodiment, the I/O controller transmits the data between the plurality of servers and the plurality of storage media according to a mapping table which divides the plurality of storage media into a plurality of regions and stores information of the servers that correspond to the plurality of regions.

In an exemplary embodiment, the divided regions include a private block in which an operating system is stored and which is allocated to a specific server and a virtual block which is a region that the respective servers share.

In an exemplary embodiment, the switch is connected to the plurality of servers in a PCI express method and is connected to the I/O controller in the PCI express method such that the storage system and the plurality of servers are directly connected.

In an exemplary embodiment, the I/O controller and the storage media are connected to each other without using a cable.

In an exemplary embodiment, the I/O controller and the storage media are connected to each other through a printed circuit board.

In an exemplary embodiment, the I/O controller transmits/receives data with respect to the server through a common interface bus of the server and transmits/receives the transmitted/received data through a preset communication interface by the storage and the storage media.

In an exemplary embodiment, the I/O controller converts a signal that is received through the common interface bus to correspond to the preset communication interface and converts a signal that is received through the communication interface used by the storage media to correspond to the common interface bus.

Exemplary embodiments of the present disclosure also provide a storage system connectable to a server including a common interface bus, the storage system comprising: a storage including a plurality of storage media; and an I/O controller to transmit/receive data between the plurality of storage media and a plurality of processor modules in the server through the common interface bus according to a mapping table stored in the I/O controller.

In an exemplary embodiment, the storage includes a circuit board including 48 storage slots provided in rows, each storage slow configured to be connected to two storage media.

In an exemplary embodiment, the I/O controller comprises at least two I/O controllers and the storage media are divided into groups, each group corresponding to a respective one of the at least two I/O controllers.

In an exemplary embodiment, the mapping table divides the storage media into a plurality of regions and stores information of the servers that correspond to the plurality of regions.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating the configuration of a server system according to an exemplary embodiment of the present disclosure;

FIG. 2 is a block diagram illustrating the connection configuration of a server system according to an exemplary embodiment;

FIG. 3 is a block diagram illustrating the connection configuration of a server system according to another exemplary embodiment;

FIG. 4 is a diagram explaining a connection state between a storage and an I/O controller of FIG. 2 or 3;

FIG. 5 is a block diagram illustrating a configuration of a storage system in FIG. 1;

FIG. 6 is a block diagram illustrating a shape of a storage system in FIG. 1;

FIGS. 7 and 8 are views illustrating a board of FIG. 5;

FIG. 9 is a view illustrating in detail connection between an I/O controller and a board;

FIG. 10 is a view illustrating a shape of an I/O controller in FIG. 1;

FIGS. 11A and 11B are views illustrating an arrangement shape of storage media;

FIGS. 12A to 12C are views illustrating a storage module according to an embodiment of the present disclosure;

FIGS. 13 and 14 are diagrams explaining a power management operation of BMC;

FIG. 15 is a block diagram illustrating the concrete configuration of a micro server in FIG. 1,

FIG. 16 is a block diagram illustrating the configuration of a processor module in FIG. 15;

FIG. 17 is a flowchart illustrating a method for transmitting and receiving data according to an embodiment of the present disclosure; and

FIG. 18 is a diagram explaining the transfer operation of a matching table.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

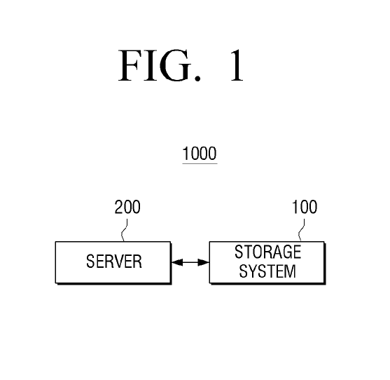

FIG. 1 is a block diagram illustrating the configuration of a server system according to an embodiment of the present disclosure.

Referring to FIG. 1, a server system 1000 according an embodiment includes a storage system 100 and a micro server 200.

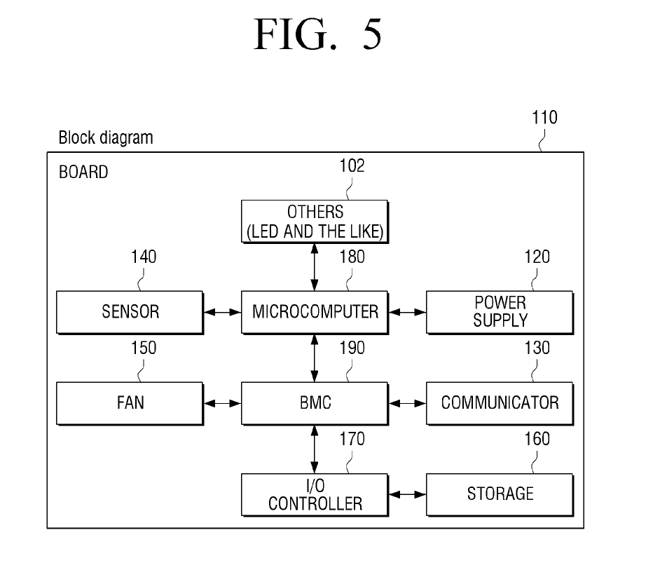

The storage system 100 includes a storage medium, and may provide data stored in the storage medium to the micro server 200 or may store data that is provided from the micro server 200 to the storage medium 100. The detailed configuration and operation of the storage system 100 will be described with reference to FIG. 5.

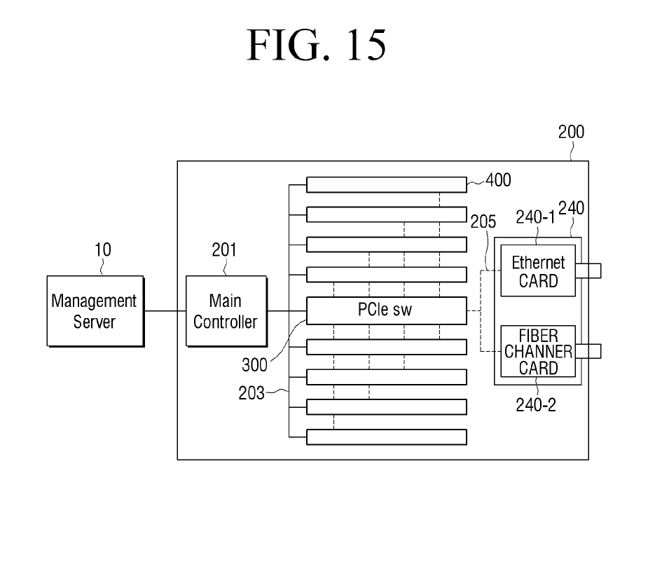

The micro server 200 is a computer system that provides a service to another computer using a plurality of processor modules, and includes a common interface bus to connect the plurality of processor modules and an external I/O device to each other. Further, the micro server 200 transmits/receives data with respect to the storage system 100 using the common interface bus. The detailed configuration and operation of the micro server 200 will be described later with reference to FIG. 15.

As described above, with the server system 1000 according to this embodiment, the micro server 200 and the storage system 100 can perform communication with each other using a common interface bus without any additional controller (e.g., FC or Ethernet). Further, the storage system 100 is directly connected to a bus in the micro server 200, and thus rapid response becomes possible.

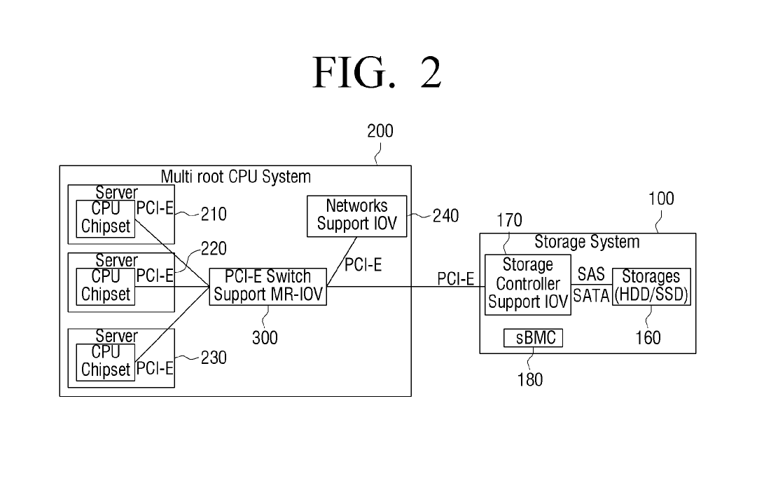

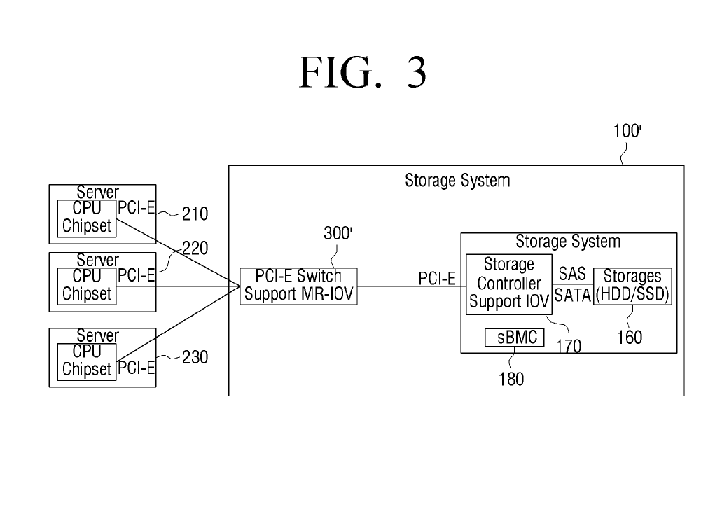

Although FIG. 1 illustrates that the storage system 100 is connected to one server 200, the storage system 100 may be connected to a plurality of servers in implementation. In this case, the storage system and the plurality of servers may be implemented through I/O virtualization. A switch to perform the I/O virtualization may be provided on the server side of the system 1000 or may be provided in the storage system 100 side of the system 1000. A case where the switch is arranged on the server 200 side will be described with reference to FIG. 2, and a case where the switch is arranged in the storage system 100 side will be described with reference to FIG. 3.

FIG. 2 is a block diagram illustrating the connection configuration of a server system according to an exemplary embodiment. Specifically, in the server system according to the embodiment of FIG. 2, the switch for the I/O virtualization is arranged on the micro server 200 side of the system. Here, the I/O virtualization refers to a technology in which several servers (or a plurality of micro servers) simultaneously use one I/O card.

Referring to FIG. 2, the storage system 100 includes a storage 160, an I/O controller 170, and a BMC (Baseboard Management Controller) 180.

The storage 160 may store data that is transferred under the control of the I/O controller 170 or may provide the stored data to the I/O controller 170. Specifically, the storage 160 includes a plurality of storage media, and the storage media may be a HDD (Hard Disk Drive) or a SSD (Solid State Disk). On the other hand, in implementation, the storage 160 may include only a plurality of HDDs, a plurality of SSDs, or a combination of the HDD and the SSD.

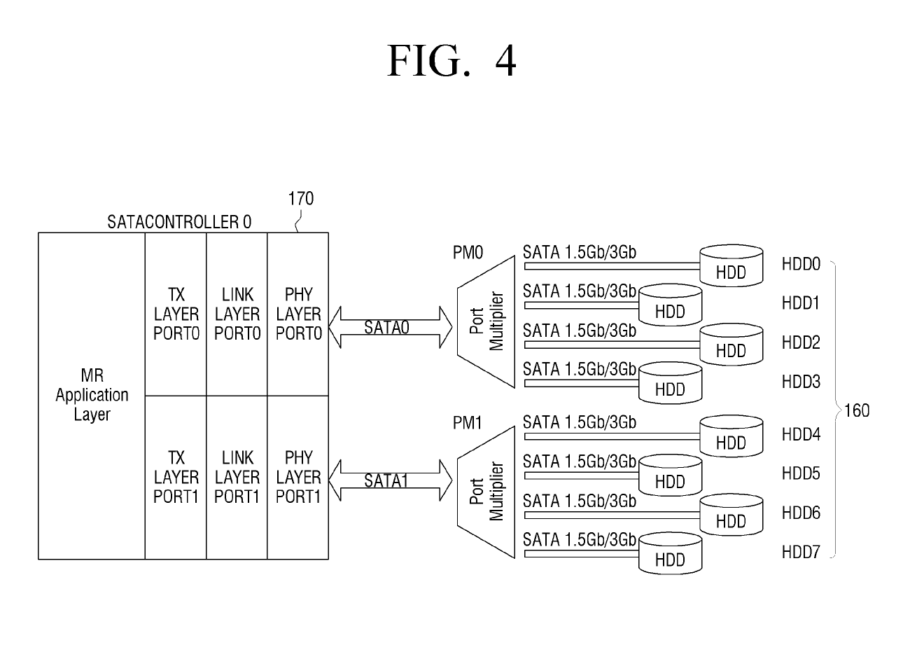

The I/O controller (or I/O adaptor) 170 may transmit/receive data with respect to the micro server 200, and transmit/receive the transmitted/received data with respect to the storage 160. Specifically, the I/O controller 170 is connected to a switch 300 of the micro server 200 through a common interface (e.g., PCI express), and is connected to the storage 160 through a preset interface. The connection state between the storage 160 and the I/O controller 170 will be described later with reference to FIG. 4.

The micro server 200 may include a plurality of processor modules 210, 220, and 230, a switch 300, and an I/O device 240.

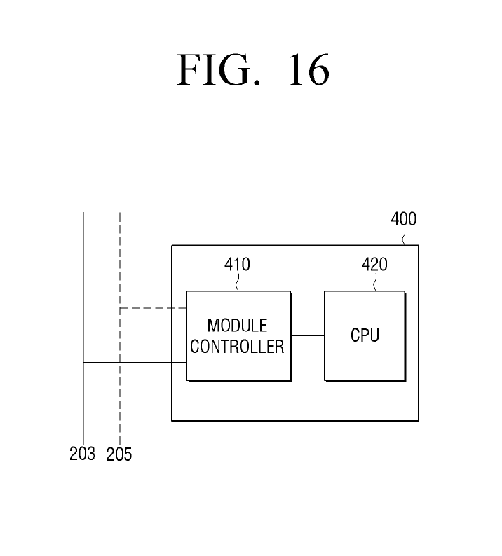

The processor modules 210, 220, or 230 is a device that has built-in core elements, such as at least one CPU (Central Processing Unit), a storage device, and an operating system, and functions as a server which receives power supply or the like from the main body as shown in FIG. 15. The detailed configuration and function of the processor module will be described later with reference to FIG. 16.

The I/O device 240 includes at least one I/O card and transmits/receives data with respect to an outside of the micro server 200. Here, the I/O card may be implemented by an Ethernet card or a fiber channel card.

Further, the I/O device 240 may receive/transmit data with respect to an external device or an external network.

Here, the data may be transmitted or received with respect to the plurality of processor modules 210, 220, and 230 through the PCI express interface, and the connection to the processor module 400 may be controlled by the switch 300.

The switch 300 may selectively connect the I/O device 240 and the plurality of processor modules 210, 220, and 230 to each other. Specifically, under the control of a main controller 201 (see FIG. 15), the switch 300 selectively connects the data received from the I/O device 240 to any one of the plurality of processor modules 210, 220, and 230 to transmit the data thereto. Here, the switch 300 may be a logic circuitry that supports SR-IOV (Single Root-Input Output Virtualization) or MR-IOV (Multi Root-Input Output Virtualization).

Further, the switch 300 may selective connect the storage system 100 and the plurality of processor modules 210, 220, and 230 to each other. Specifically, under the control of the main controller 201 (FIG. 15), the switch 300 selectively connects the data received from the I/O controller 170 of the storage system 100 to any one of the plurality of processor modules 210, 220, and 230 to transmit the data thereto.

On the other hand, the switch 300 may comprise a PCI express switch circuit (or MRA PCIe switch), and may selectively adjust the connection relationship between the plurality of processor modules 210, 220, and 230 and at least one I/O card (end point device).

The switch 300 may implement the I/O virtualization technology. Here, the I/O virtualization technology refers to a technology that several processor modules (or CPU boards) and root complex are connected to one I/O card through a PCIe bus and simultaneously use the one I/O card.

Although FIG. 2 illustrates that the storage system 100 includes only the storage 160 and the I/O controller 170, the storage system 100 may include other various components in implementation. This will be described later with reference to FIG. 5. Further, although FIG. 2 illustrates that the micro server 200 includes only the micro module, switch, and I/O device, the micro server 200 may include other various components in implementation.

FIG. 3 is a block diagram illustrating the connection configuration of a server system according to another exemplary embodiment. Specifically, in a server system according to this embodiment, a switch configuration for I/O virtualization is arranged on the storage system 100 side of the server system.

Referring to FIG. 3, a storage system 100′ includes a switch 300′, a storage 160, and an I/O controller 170. The storage system 100′ according to the exemplary embodiment of FIG. 3 is the same as that according to the embodiment of FIG. 2, except for the point that the switch 300′ is further included, and thus an explanation of the storage 160 and the I/O controller 170 will be omitted for brevity of the description.

The switch 300′ is connected to the plurality of servers 210, 220, and 230 via a PCI express method, and is connected to the I/O controller 170 also via the PCI express method.

Further, the switch 300′ may selectively connect the I/O controller 170 and the plurality of servers 210, 220, and 230 to each other. Specifically, the switch 300′ selectively connects the data received from the I/O controller 170 of the storage system 100′ to any one of the plurality of servers 210, 220, and 230 to transmit the data thereto.

On the other hand, the switch 300′ may comprise a PCI express switch circuit (or MRA PCIe switch), and may selectively adjust the connection relationship between the plurality of servers 210, 220, and 230 and at least one I/O controller 170. The switch 300′ may implement the I/O virtualization technology.

FIG. 4 is a diagram explaining a connection state between a storage and an I/O controller 170 of FIG. 3.

Referring to FIG. 4, the storage 160 comprises a plurality of storage media. Further, the plurality of storage media may be grouped into a plurality of groups. Specifically, in order to virtualize and share the storage that comprises the plurality of storage media, the plurality of storage media may be divided into a plurality of regions. The divided regions may be a private block and a virtual block. Here, the private block is a region in which the operating system is stored and which is allocated to a specific server, and the virtual block is a region that the respective servers can share. Information about the respective regions is managed as a mapping table, and the mapping table (or matching table) may be corrected by an external management server.

Accordingly, the I/O controller 170 allocates a storage medium region to the server using the mapping table in which the respective servers match blocks of the allocated storage media.

Here, the matching table information can be controlled by an external management server through a BMC. If an IPMI of the BMC provides format information of the storage media, partition information, block use information, and installed OS information to the external management server, services, such as HDD partition setting, block change, matching block size and resetting, can be provided to the IPMI of the BMC.

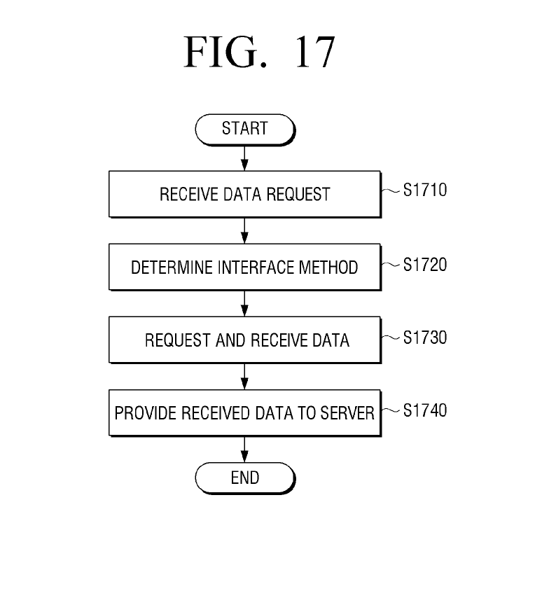

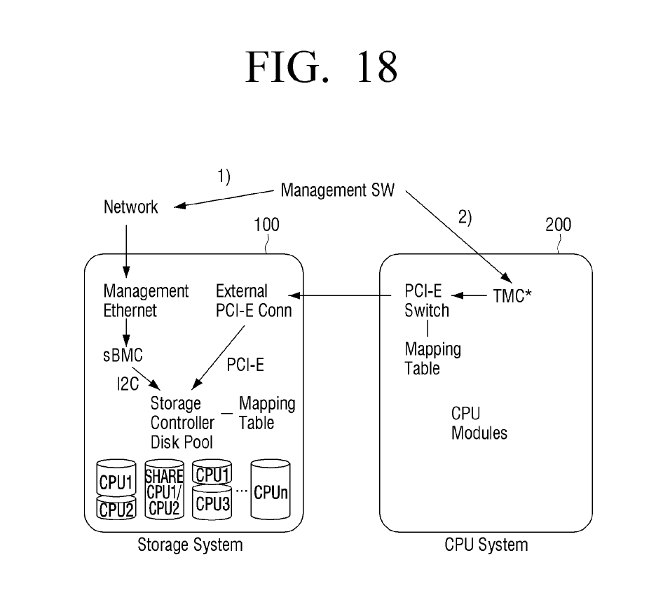

The matching table set in the external management server may be stored and used in the I/O controller 170 and a server node through S-BMC and TMC (CPU System Management Controller). Specifically, as illustrated in FIG. 17, the matching table set in the external management server may be directly transferred to the storage system 100 through the S-BMC, may be transferred to the server, and may be transferred from the server to the I/O controller 170 through a TMC.

FIG. 5 is a block diagram illustrating the configuration of a storage system according to an exemplary embodiment.

Referring to FIG. 5, a storage system 100 according to this embodiment includes a board 110, other components 102 (not necessarily directed to the operations as described herein), a power supply 120, a communicator 130, a sensor 140, a fan 150, a storage 160, an I/O controller 170, a microcomputer 180, and a BMC 190. The storage system 100 may have a size of 19×39 inches, which can be installed on a 19-inch standard rack. In the illustrated example, the storage system 100 does not include the switch as shown in FIG. 3, but may further include the switch configuration as shown in FIG. 3 in implementation.

The board 110 is a PCB (Printed Circuit Board) on which various types of components of the storage system 100 are arranged. Here, the board 110 may be a both-side PCB having conductive layers on both sides thereof, or may be a multilayer PCB in which pattern layers are buried within. The board 110 may have a size (e.g., 16.3×32.6 inches) that can be mounted on a standard server size 2U.

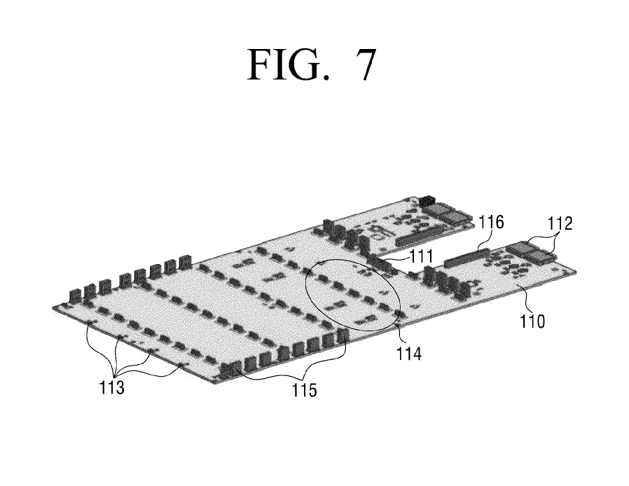

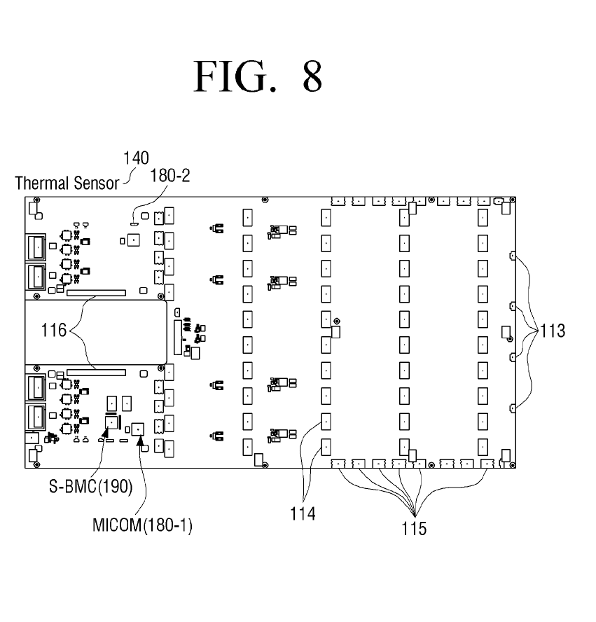

Further, the board 110 includes slots for physically/electrically connecting to respective components in the storage system 100. Specifically, the board 110 may include a power supply slot 111, a communication connector 112, a ventilation connector 113, a storage slot 114, an auxiliary connector 115, and an I/O slot 116. The function and operation of the respective slots will be described later with reference to FIGS. 7 and 8.

The board 110 includes a pattern on a circuit board (i.e., PCB) to transfer signals between the respective components in the storage system 100. Specifically, the board 110 may include a first pattern to transfer a signal between the storage 160 and the I/O controller 170 and a second pattern to transfer a signal between the I/O controller 170 and the communicator 130. Although only the first pattern and the second pattern have been described, a pattern to transfer a signal between the microcomputer and the BMC, a pattern to transfer a signal between the BMC and the I/O controller, and a pattern to transfer a signal between the microcomputer and the sensor may be further arranged. Such patterns may be arranged on an upper surface and/or a lower surface of the board, and according to circumstances, the patterns may also or alternatively be arranged on an inner layer of the PCB.

The board 110 receives the power through the power supply 120, and provides the input power to the respective components in the storage system 100 through the patterns on the circuit board.

The power supply 120 supplies the power to the respective components in the storage system 100. Specifically, the power supply 120 may be provided with a plurality of power supplies so that the power supply 120 has the power capacity that exceeds the maximum power capacity that is required in the storage system 100. Further, the power supply 120 may supply the power to the respective components in the storage system 100 through driving of the plurality of power supplies in a current-sharing method. The power supply 120 may supply the power to the storage system 100 using only a part of the plurality of power supplies.

The power supply 120 can be attached or detached through the slot formed on the board 110. Through this slot, the power supply 120 may provide whether to connect AC, whether to mount a PSU, whether an error occurs, input/output current/voltage, and temperature information to the BMC 190 through the slot.

The communicator 130 performs communication with the micro server 200. Specifically, the communicator 130 may perform communication with the micro server 200 in a PCI express interface method. In this embodiment, it is described that the communicator 130 communicates with the micro server 200 in the PCI express interface method. However, if the common interface method is an interface method other than the PCI express method, the communicator 130 may perform communication via another interface method.

Further, the communicator 130 performs communication with a management server 10 (see FIG. 15). Specifically, the communicator 130 includes a network controller and a LAN port, and enables the BMC 190 to perform communication with the management server 10. Here, the communicator 130 may perform communication with the management server 10 through a server management network channel (OOB (Out Of Band)) which is separated from the network channel that performs a service of the micro server 200.

In this embodiment, it is described that the communication is performed with the management server 10 through a wire LAN port. However, it is also possible to perform communication with the management server 10 not only in another wire communication method excluding the LAN method, but also in a wireless communication method. Further, in this embodiment, it is described that the storage system 100 is directly provided with a network controller and performs communication with the management server 10. However, in implementation, the communicator 130 may be implemented to communicate with an external device through the I/O device provided in the micro server 200. On the other hand, in this embodiment, it is described that the micro server 200 and the management server 10 have different configurations. However, in implementation, the micro server 200 may be configured to additionally perform the operations of the management server 10, thus eliminating the need for a separate management server 10.

The sensor 140 may include a plurality of sensors arranged inside the storage system and may provide sensing values sensed by the sensors to the microcomputer 180. Here, the sensor may be a temperature sensor, but is not limited thereto. On the other hand, in the case where the microcomputer 180 includes a plurality of microcomputers, the plurality of sensors are grouped into groups corresponding to the number of microcomputers, respectively, and the divided groups may transfer sensing values to the corresponding microcomputers, respectively.

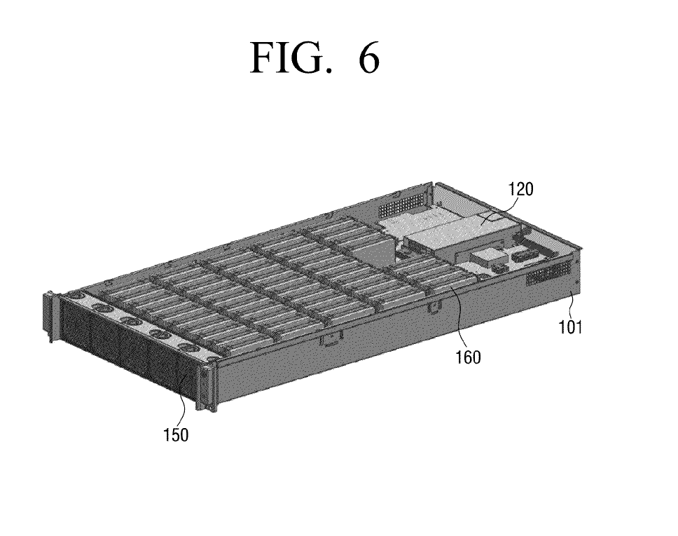

The fan 150 causes air to flow into the storage system 100. Specifically, the fan 150 is illustrated in FIG. 6 as being disposed on a front surface of the storage system 100, and may cool the storage system 100 by causing external air to flow into the storage system 100. The operation of the fan 150 may be controlled by the microcomputer 180 to be described later.

The storage 160 may store transferred data or may provide the stored data to the I/O controller 170 under the control of the I/O controller 170. Specifically, the storage 160 may include a plurality of storage media, and the storage medium may be a HDD (Hard Disk Drive) or a SSD (Solid State Disk). On the other hand, in implementation, the storage 160 may include a plurality of HDDs only, a plurality of SSDs only, or a combination of the HDD and the SSD.

In the case where a plurality of I/O controllers 170 are provided, the plurality of storage media are grouped into groups corresponding to the number of I/O controllers 170, and the respective divided groups of storage media may transmit/receive data with respect to the corresponding I/O controllers 170, respectively. For example, in this embodiment, 96 storage media may be arranged in the storage system 100, and two I/O controllers 170 may each perform communication with 48 storage media.

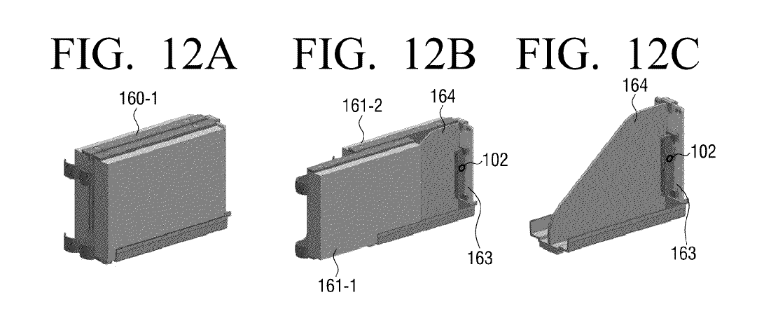

The plurality of storage media constituting the storage 160 can be attached or detached through the slot formed on the board 110. The connection method between the storage media and the board 110 will be described later with reference to FIG. 12.

The storage 160 may perform a de-emphasis process with respect to a signal that is transmitted to the I/O controller 170, and may perform an equalizer process with respect to a signal that is received from the I/O controller 170.

The I/O controller (or I/O adapter) 170 transmits/receives data with respect to the micro server 200 through the communicator 130 and transmits/receives the transmitted/received data with respect to the storage 160. Specifically, the I/O controller 170 may enable the micro server 200 to share and use storage spaces of the plurality of storage media. In implementation, the I/O controller 170 may also enable the plurality of micro servers 200 to use the storage spaces of the plurality of storage media.

The I/O controller 170 transmits/receives data with respect to the server 200 through the common interface bus and transmits/receives the transmitted/received data through the communication interface that is used by the storage and the storage media. Specifically, the I/O controller 170 converts a signal that is received through the common interface bus to correspond to the preset communication interface and converts a signal that is received through the storage media to correspond to the common interface bus. The common interface bus may be a PCI express interface bus, and the interface bus may be at least one of SAS (Serial Attached SCSI), SATA (Serial ATA), and NVMe (Non Volatile Memory express).

The I/O controller 170 transmits/receives data between the plurality of storage media and the servers according to a preset mapping table. For example, if the data that is transmitted from a specific server A is received, the I/O controller 170 may search for a storage region that is allocated to the specific server A using the mapping table, and may transmit/receive the data with respect to the storage media corresponding to the searched (allocated) storage region. The mapping table may be received from the external management server through the BMC 190, and may be directly received from the server 200.

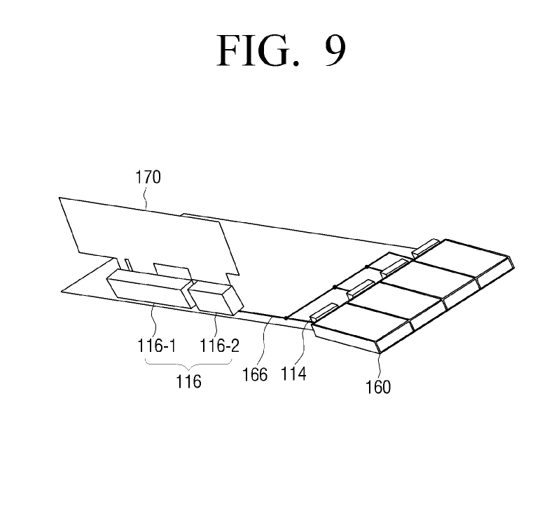

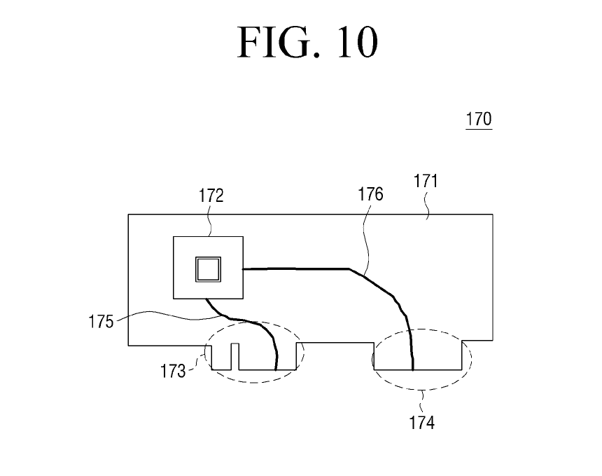

The I/O controller 170 can be attached or detached through the slot formed on the board 110. Specifically, the connection method between the I/O controller 170 and the board 110 will be described later with reference to FIGS. 9 and 10.

The I/O controller 170 adjusts the bandwidth of the common interface bus. Specifically, the I/O controller 170 may adjust the bandwidth of the common interface bus with the micro server 200 according to the number of channels with the micro server 200. On the other hand, if the storage system 100 is connected to the plurality of servers, the I/O controller 170 may adjust the bandwidth between the plurality of servers.

The I/O controller 170 may perform replication of the data and may store the replicated data in the plurality of storage media. Specifically, the I/O controller 170 may support a RAID (Redundant Array of Independent Disks) function. Here, RAID is a technique that dividedly stores partial replicated data through the use of several storage media as one storage medium.

The I/O controller 170 may perform a de-emphasis process with respect to a signal that is transmitted to the storage medium or the server and may perform an equalizer process with respect to a signal that is received from the storage medium or the server.

Specifically, a serial bus refers to an interface that transmits data in units of one bit at a time, and since serial busses of the most recent technology operate at a high speed, ISI (Inter-Symbol-Interference or inter-code-interference), skin effect (or propagation effect), and dielectric loss may occur. Here, the skin effect refers to the decrease of conductivity or the increase of electrical resistivity that is observed when a fluid inspection survey is performed in a material having high conductivity, and the dielectric loss is a loss that occurs when an AC electric field is applied to a dielectric material. The ISI refers to an interference in which a symbol waveform of any one time slot exerts an influence on a symbol waveform of another time slot due to band limits by a transfer path or an amplifier or non-linearity of phase characteristics of a transfer path.

The ISI as described above may be corrected using a de-emphasis technology or equalizer technology. Specifically, at a transmission terminal of a serial bus (e.g., output terminal Tx of the storage medium or output terminal of the I/O controller), a signal is transmitted in consideration of an influence of the ISI using the de-emphasis technology, and at a reception terminal of the serial bus (e.g., reception terminal Rx of the storage medium or reception terminal of the I/O controller), the received waveform can be improved using the equalizer technology.

Then, the I/O controller 170 may support hot swap with respect to the storage media. Here, the hot swap is a function that can replace a device or a component without exerting an influence on the operation of the whole system that is being operated. Since the above-describe function is supported, the replacement/restoration of the storage media can be performed even in the case where the storage system 100 is being operated.

Further, in the case where the HDD is used as the storage medium, the I/O controller 170 may control the storage 160 to sequentially drive respective HDDs to reduce the whole power load of the storage system. Specifically, in order to prevent the system instability due to power consumption during a spin-up process of initial HDDs, the I/O controller 170 sequentially drives a plurality of HDDs (staggered drive spin-up).

The I/O controller 170 may include a memory that temporarily stores data between the micro server 200 and the storage medium. Here, the memory may be a RAM or a flash memory of 1 G or more.

The microcomputer 180 collects and provides status information of the plurality of storage media and status information of the interior of the storage system to the BMC 190. Here, the status information of the storage media may be S.M.A.R.T (Self-Monitoring, Analysis and Reporting Technology) information of the HDD, and the status information of the interior of the storage system may be determined by the temperature sensed by the sensor 140 and the power supply state of the power supply 120. Further, the S.M.A.R.T information may be self-diagnosis information of the HDD for determining basic mechanical abnormality, such as head height, data transfer speed, disk RPM, the number of sectors, access error rate, access speed, and HDD stop frequency, and pre-notifying of any possibility of trouble.

The microcomputer 180 controls the operations of the storage system according to a command provided from the BMC 190. Specifically, if a high temperature value of the interior of the storage system 100 is input through the sensor 140 and is provided to the BMC 190, the BMC 190 may transmit an operation control command for the fan 150, and the microcomputer 180, which has received this operation control command, may control the fan 150. In implementation, the microcomputer 180 may be divided into a plurality of microcomputers.

The BMC 190 provides an IPMI service for the storage system. The BMC 190 is a microprocessor that can be mounted at either the server or the storage system which supports IPMI, which may provide information collected by the microcomputer 180 and media management information collected from the plurality of storage media to the management server 10, provide a control command provided from the management server 10 to the microcomputer 180, and manage the temperature and power of the system. In this case, the BMC 190 may divide the plurality of storage media into a plurality of groups and may perform power management and operation management by groups. Here, the media management information is information regarding a manufacture, capacity, speed, error history, temperature, and health of the storage media.

Here, the IPMI is the open-type standardized hardware management interface standard that defines a specific method in which an embedded management lower system can perform communication, and may perform monitoring, logging, recovery, inventory, and hardware control for the processor module. In this embodiment, it is described that one BMC collects the status information of the plurality of microcomputers and transmits the status information to the management server 10. However, it is also possible to use a plurality of BMCs.

Further, if a disk allocation request is received from the management server 10, the BMC 190 may request the I/O controller 170 to allocate disk resources. In this case, the BMC 190 and the I/O controller 170 may be connected to each other through an SMBus interface.

Here, the SMBus (System Management Bus) interface is a simple 2-line bus that is used to communicate with low-speed devices on the mother board, and is an interface based on the I²C serial bus protocol.

The BMC 190 may request an integrated management solution to perform disk resetting or disk change according to loads of the respective storage media based on the media management information received from the storage media. For example, a host (server) having high random access frequency may be allocated with SSD resources having high access speed, and a host (server) having high write frequency may be allocated with HDD resources.

As described above, the storage system 100 according to this embodiment perform communication with the micro server in the common interface method, and thus the storage system 100 can perform communication without any additional controller (e.g., FC or Ethernet). Further, since the storage system 100 is directly connected to the bus in the micro server 200, a rapid response becomes possible.

The storage system 100 according to this embodiment connects the storage media and the I/O controller 170 to each other without using a cable, and thus the connection structure in the storage system can be simplified. Accordingly, it is possible to arrange a large number of storage media. Further, the I/O controller 170 can be attached or detached through the slot, and an upgrade of the system can be easily performed through only replacement of the I/O controller 170. Further, the connection structure is simplified without cables, and thus the cooling effect of the system can be improved.

FIG. 6 is a block diagram illustrating the shape of the storage system of FIG. 1.

Referring to FIG. 6, a chassis 101 surrounds the storage system 100. The chassis 101 may have a horizontal and vertical sizes (19×3.5 inches and 39 inches (W×H×D), which can be installed on the 19-inch standard rack.

At a front end of the chassis 101, the fan 150 to supply external air into the storage system 100 is disposed. In this exemplary embodiment, it is illustrated that the fan is arranged only at the front end of the chassis 101, but in implementation, the fan 150 may be disposed on the rear end and the side surface of the chassis 101.

The communicator 130 that performs communication with the server and the power supply 120 that supplies the power are arranged at the rear end of the chassis 101. Here, the communicator 130 may be connected to the micro server 200 through a cable according to the PCI express cable standard.

On the other hand, FIG. 6 illustrates that the storage system 100 according to this embodiment has a size enough to be installed on the 19-inch standard rack. In implementation, however, the storage system 100 may be implemented with a size other than a size to be installed on the 19-inch standard rack.

FIGS. 7 and 8 are views illustrating the shape of a board of FIG. 5.

Referring to FIGS. 7 and 8, the board 110 has a rectangular shape that can be mounted on a standard server rack, and has grooves formed therein to arrange the power supply 120 at the rear end of the board 110.

On an upper surface and/or a lower surface of the board 110, a pattern to transfer signals between the respective configurations in the storage system 100 may be arranged. Such a pattern may be formed on a layer in the circuit board.

On the board 110, connectors/slots for electrically/physically connecting to the respective components in the storage system 100 are arranged. Specifically, the board 110 may include a power supply slot 111, a communication connector 112, a fan connector 113, a storage slot 114, an auxiliary connector 115, and an I/O slot 116.

The power supply slot 111 is a slot to physically/electrically connect various types of terminals of the power supply 120 to the board 110, and the power of the power supply 120 is transferred to the respective components in the storage system 100 through the power supply slot 111. Further, through the power supply slot 111, the microcomputer 180 may sense the operating state of the power supply 120 and may control the operation of the power supply 120.

The communication connector 112 is a connector to physically/electrically connect the storage system 100 to the micro server 200, and for easy connection to the server 200, the communication connector 112 is arranged on the rear end side of the board 110. The communication connector 112 may be a connector connectable to a cable according to the PCI express cable standard. In this embodiment, only the communication connector 112 to be connected to the micro server 200 is illustrated and described. In implementation, however, an additional connector for connection to the Ethernet or to the management server 10 (see FIG. 15) may be arranged.

The fan connector 113 is a connector to physically/electrically connect various kinds of terminals of the fan 150 to the board 110, and is arranged on the front end side of the board 110. Further, the fan connector 113 transfers the power of the power supply 120 to the fan 150. Through the fan connector 113, the microcomputer 180 may sense the operating state of the fan 150 and may control the operations of the fan 150.

The storage slot 114 is a connector to physically/electrically connect the storage media to the board 110, and may be a SATA connector. Further, the storage slot 114 transfers the power of the power supply 120 to the storage media, and connects the I/O (Input/Output) port between the storage media and the I/O controller 170.

The storage slot 114 is arranged on the board 110, and the storage media are arranged in a length direction (direction in which a surface having the longest length of the storage media is perpendicular to the length of the board). In this case, the height of the storage system 100 may be higher than the length direction of the storage media, and in order to reduce the height of the storage system 100, using the auxiliary substrate, the storage media may be arranged in the horizontal direction (the second long length of the storage media. An example of using an auxiliary substrate will be described later with reference to FIG. 12.

The storage system 100 according to this embodiment may be provided with 48 storage slots provided along rows in the width direction of the 19-inch standard rack as illustrated in FIG. 8, and each slot can be connected to two storage media. Accordingly, the storage system 100 according to this embodiment can use 96 storage media.

In the case of using 96 storage media on one I/O board, there may be a difficulty in connection, and the storage system 100 according to this embodiment uses two I/O controllers and two microcomputers. In this embodiment, the plurality of storage media are divided into two groups. In implementation, however, the plurality of storage media may be provided in one group, or may be divided into three or more groups. On the other hand, different types of power supply control/operation control may be performed by groups using the BMC.

The auxiliary connector 115 is a connector for compatibility with an I/O controller in the related art. Specifically, in the related art, the I/O controller and the storage media are connected to each other through a cable. Accordingly, in this embodiment, for compatibility with the I/O controller in the related art, which can be connected to the storage media using the cable only, the auxiliary connector 115 that is connected to the pattern between the storage media and the I/O controller is arranged on one side of the board 110.

Further, in order not to disturb the air flow in the storage system 100, the auxiliary connector 115 is arranged at both sides of the board 110. The auxiliary connector 115 may be a 4-port SATA/SAS connector. Since the auxiliary connector is only for compatibility with the I/O controllers in the related art setups, but is not an essential configuration for the exemplary embodiments herein, it may be omitted in implementation.

The I/O slot 116 is a slot to physically/electrically connect the I/O controller 170 to the board 110, and may include a first slot and a second slot. This will be described hereinafter with reference to FIGS. 9 and 10.

FIG. 9 is a view illustrating in detail connection between an I/O controller 170 and a board 110, and FIG. 10 is a view illustrating the shape of an I/O controller 170 in FIG. 1.

Referring to FIGS. 9 and 10, the I/O controller 170 includes a sub-board 171 and a chip 172.

The sub-board 171 includes a first slot 173 and a second slot 174 that are arranged on one side to be spaced apart from each other. Here, the first slot 173 transmits/receives a signal 165 between the communicator 130 and the chip 172, and may have a pin arrangement standard of the PCI express interface. The first slot 173 may transmit/receive data and a control command between the server and the I/O controller in a first interface bus method. Here, the first interface bus method may be a PCI express interface bus method.

Here, the PCI (Peripheral Component Interconnect) express interface maintains softwired compatibility with the PCI parallel interface bus in the related art, and is a local bus standard of an improved serial structure for high-speed input/output between devices. The PCI express interface is suitable to the large-capacity data process.

The second slot 174 may transmit/receive a signal 166 between the plurality of storage media and the chip 172, and may have a pin arrangement as shown in Table 1 below. The second slot 174 may transmit/receive data and control commands between the plurality of storage media and the I/O controller through the second interface bus. Here, the second interface bus may be at least one of SAS (Serial Attached SCSI), SATA (Serial ATA), and NVMe (Non Volatile Memory express).

Here, the SAS is one standard of serial SCSI, and is a high-speed interface through which data is sequentially transmitted by one bit and thus the data can be easily synchronized.

The SATA is one of computer buses for the main purpose of data transmission with a hard disk or optical drive, and transmits/receives the data using four signal lines TX−, TX+, RX−, and RX+. In this regard, in order to connect 12 SATA disks, total 84 pins including ground are required. The respective pin mapping is as shown in Table 1, and 84 pins can be implemented by one connector for PCI express×4.

The NVMe (Non Volatile Memory express) is an interface for storage media using a nonvolatile memory, such as the SSD.

TABLE 1

| Pin# | Signal Name |
|---|---|
| A1 | PORT0_SAS_TXP |
| A2 | PORT0_SAS_TXN |
| A3 | GND |
| A4 | PORT0_SAS_RXP |
| A5 | PORT0_SAS_RXN |
| A6 | GND |
| A7 | PORT1_SAS_TXP |
| A8 | PORT1_SAS_TXN |
| A9 | GND |
| A10 | PORT1_SAS_RXP |
| A11 | PORT1_SAS_RXN |
| A12 | GND |
| A13 | PORT2_SAS_TXP |
| A14 | PORT2_SAS_TXN |
| A15 | GND |
| A16 | PORT2_SAS_RXP |
| A17 | PORT2_SAS_RXN |
| A18 | GND |
| A19 | PORT3_SAS_TXP |
| A20 | PORT3_SAS_TXN |
| A21 | GND |
| A22 | PORT3_SAS_RXP |
| A23 | PORT3_SAS_RXN |
| A24 | GND |
| A25 | PORT4_SAS_TXP |
| A26 | PORT4_SAS_TXN |
| A27 | GND |
| A28 | PORT4_SAS_RXP |
| A29 | PORT4_SAS_RXN |
| A30 | GND |
| A31 | PORT5_SAS_TXP |
| A32 | PORT5_SAS_TXN |
| A33 | GND |
| A34 | PORT5_SAS_RXP |
| A35 | PORT5_SAS_RXN |
| A36 | GND |
| A37 | PORT6_SAS_TXP |
| A38 | PORT6_SAS_TXN |
| A39 | GND |
| A40 | PORT6_SAS_RXP |
| A41 | PORT6_SAS_RXN |
| A42 | GND |
| A43 | PORT7_SAS_TXP |
| A44 | PORT7_SAS_TXN |
| A45 | GND |
| A46 | PORT7_SAS_RXP |
| A47 | PORT7_SAS_RXN |
| A48 | GND |
| A49 | PORT8_SAS_TXP |
| A50 | PORT8_SAS_TXN |
| A51 | GND |
| A52 | PORT8_SAS_RXP |
| A53 | PORT8_SAS_RXN |
| A54 | GND |
| A55 | PORT9_SAS_TXP |
| A56 | PORT9_SAS_TXN |
| A57 | GND |
| A58 | PORT9_SAS_RXP |
| A59 | PORT9_SAS_RXN |
| A60 | GND |
| A61 | PORT10_SAS_TXP |
| A62 | PORT10_SAS_TXN |
| A63 | GND |
| A64 | PORT10_SAS_RXP |
| A65 | PORT10_SAS_RXN |
| A66 | GND |
| A67 | PORT11_SAS_TXP |
| A68 | PORT11_SAS_TXN |
| A69 | GND |
| A70 | PORT11_SAS_RXP |
| A71 | PORT11_SAS_RXN |
| A72 | GND |
| B1 | PORT12_SAS_TXP |
| B2 | PORT12_SAS_TXN |
| B3 | GND |
| B4 | PORT12_SAS_RXP |
| B5 | PORT12_SAS_RXN |
| B6 | GND |
| B7 | PORT13_SAS_TXP |
| B8 | PORT13_SAS_TXN |
| B9 | GND |
| B10 | PORT13_SAS_RXP |
| B11 | PORT13_SAS_RXN |
| B12 | GND |
| B13 | PORT14_SAS_TXP |
| B14 | PORT14_SAS_TXN |
| B15 | GND |
| B16 | PORT14_SAS_RXP |
| B17 | PORT14_SAS_RXN |
| B18 | GND |
| B19 | PORT15_SAS_TXP |
| B20 | PORT15_SAS_TXN |
| B21 | GND |
| B22 | PORT15_SAS_RXP |
| B23 | PORT15_SAS_RXN |
| B24 | GND |
| B25 | PORT16_SAS_TXP |
| B26 | PORT16_SAS_TXN |
| B27 | GND |
| B28 | PORT16_SAS_RXP |
| B29 | PORT16_SAS_RXN |
| B30 | GND |
| B31 | PORT17_SAS_TXP |
| B32 | PORT17_SAS_TXN |
| B33 | GND |
| B34 | PORT17_SAS_RXP |
| B35 | PORT17_SAS_RXN |
| B36 | GND |
| B37 | PORT18_SAS_TXP |
| B38 | PORT18_SAS_TXN |
| B39 | GND |
| B40 | PORT18_SAS_RXP |
| B41 | PORT18_SAS_RXN |
| B42 | GND |
| B43 | PORT19_SAS_TXP |
| B44 | PORT19_SAS_TXN |
| B45 | GND |
| B46 | PORT19_SAS_RXP |
| B47 | PORT19_SAS_RXN |
| B48 | GND |
| B49 | PORT20_SAS_TXP |
| B50 | PORT20_SAS_TXN |
| B51 | GND |
| B52 | PORT20_SAS_RXP |
| B53 | PORT20_SAS_RXN |
| B54 | GND |
| B55 | PORT21_SAS_TXP |
| B56 | PORT21_SAS_TXN |
| B57 | GND |
| B58 | PORT21_SAS_RXP |
| B59 | PORT21_SAS_RXN |
| B60 | GND |
| B61 | PORT22_SAS_TXP |
| B62 | PORT22_SAS_TXN |
| B63 | GND |
| B64 | PORT22_SAS_RXP |
| B65 | PORT22_SAS_RXN |
| B66 | GND |
| B67 | PORT23_SAS_TXP |
| B68 | PORT23_SAS_TXN |
| B69 | GND |
| B70 | PORT23_SAS_RXP |
| B71 | PORT23_SAS_RXN |
| B72 | GND |

As described above, the I/O e recontroller 170 according to this embodiment is connected to the board 110 through the slots, and the I/O controller 170 can be attached to or detached from the system. Accordingly, the system can be upgraded only through replacement of the existing I/O controller by an improved I/O controller.

FIGS. 9 and 10 illustrate that the first slot and the second slot are spaced apart from each other, but in implementation, the first slot and the second slot may not be spaced apart from each other. That is, the first slot and the second slot may be implemented through one physical slot.

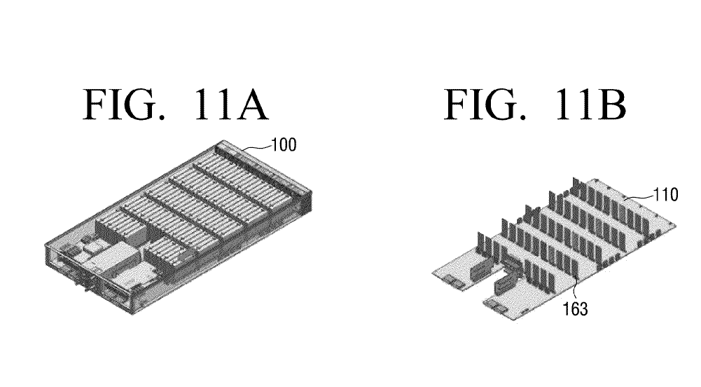

FIGS. 11A and 11B are views illustrating the arrangement shape of storage media, and FIGS. 12A to 12C are views illustrating a storage module according to an embodiment of the present disclosure.

Referring to FIGS. 11A and 11B, the storage 160 according to this embodiment includes a plurality of storage modules 160-1. The storage modules 160-1 are arranged on the board 110 with a preset gap between them. Since the storage modules are arranged with the preset gap, air that flows through the fan 150 and into the storage system 100 can reach the opposite side of the storage system 100 as it passes between the storage modules.

Referring to FIGS. 12A to 12C, one storage module 160-1 is connected to the board 110 through one sub-board 163 and a bracket 164.

The sub-board 163 can be attached to or detached from the storage slot of the board 110, and includes two slots which can be attached to or detached from the connector of the storage media. In this embodiment, it is described that two slots are provided on the sub-board 163, but in implementation, only one slot may be provided as required.

On the sub-board 163, a display element, such as an LED 102, for displaying the operation state of the storage media connected thereto may be provided. Since the display element displays the operation state and an error state of the storage media, a user (i.e., a manager of the storage system 100) can easily find a problematic storage medium among a large number of storage media.

The bracket 164 fixes two storage media and the sub-board 163 to the board.

As described above, since the storage media can be connected to the board through the slots, hot swap with respect to the storage media can be supported. Here, hot swap is a function that can replace a device or a component without exerting an influence on the operation of the whole system.

In this embodiment, it is described that the storage media are connected to the board 110 through the sub-board. However, if the height of the storage system 100 is higher than the length (longest length among width, length, and height) of the HDD, the storage media can be vertically mounted on the board 110 without using the sub-board. At this time, the display element, such as an LED, for displaying the operation state of the storage media can be arranged on the board 110.

On the other hand, in the case of using the sub-board as in the illustrated example, a 2.5-inch HDD may be used as the storage media in a 2U system.

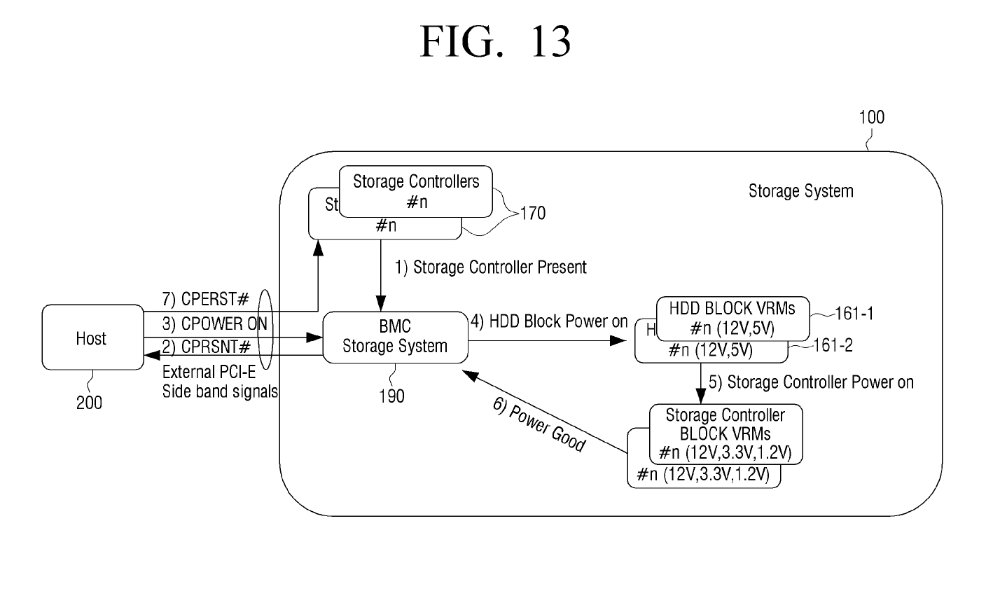

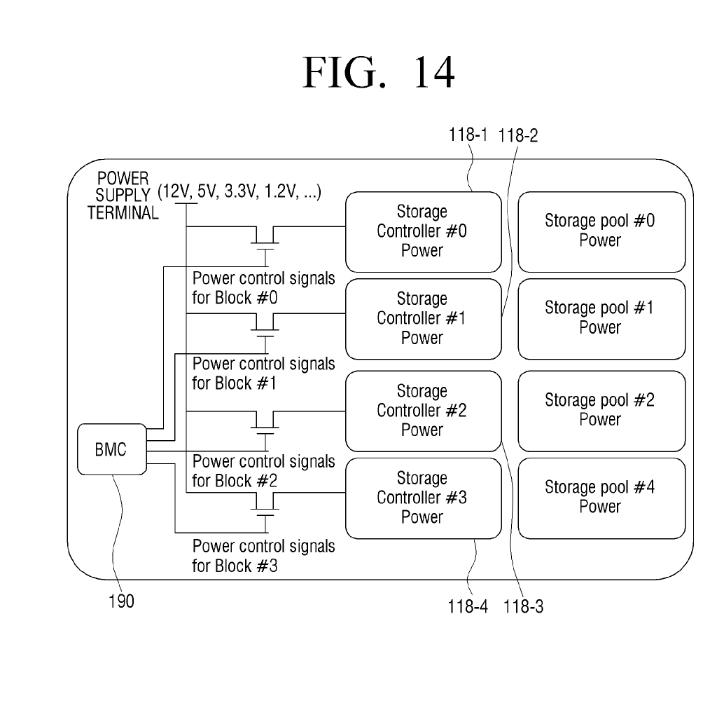

FIGS. 13 and 14 are diagrams explaining a power management operation of BMC.

Referring to FIGS. 13 and 14, the BMC 190 may receive various types of signals (e.g., present/power-on/reset) to control the storage system 100 from the micro server 200, and may control the operation of the plurality of storage media in the storage system 100 according to the received information.

Specifically, the plurality of storage media 161 may be divided into a plurality of groups as described above, and the power supply 120 may individually supply the power by groups. Specifically, a plurality of switches may be provided on the board 110, and the BMC 190 may control the operation of the plurality of switches to vary the power supply state by groups.

FIG. 15 is a block diagram illustrating the concrete configuration of a micro server in FIG. 1.

Referring to FIG. 15, the micro server 200 includes an I/O (Input/Output) device 240, a main controller 201, a common interface bus 203, a switch 300, and processor modules 400.

The I/O device 240 includes at least one I/O card, and transmits/receives data with respect to an outside of the micro server 200. Here, the I/O card may be implemented by Ethernet card 240-1 and fiber channel card 240-2.

On the other hand, the I/O device 240 may receive/transmit the data with respect to an external device (e.g., management server) or an external network.

Here, the data may be transmitted or received with respect to the processor modules 400 through the PCI express interface, and the connection to each processor module 400 may be controlled by the switch 300. The details of the switch 300 will be described later.

The main controller 201 controls the respective configurations of the micro server 200. Specifically, the main controller 201 may control the switch 300 so that the data that is transmitted through the I/O device 240 can be transmitted to the respective processor modules 400 using the common interface bus 203.

Further, the main controller 201 may control the switch 300 so that the data that is transmitted from the storage system 100 through the common interface bus 203 can be transmitted to the respective processor modules 400.

Further, the main controller 201 may operate to transmit control commands transmitted from the management server 10 to the respective processor modules 400 using the common interface bus 203.

The main controller 201 controls the respective processor modules 400 mounted on the micro server 200 to configure specified systems, such as a web server, an FTP server, a mail server, and a database server. As an example, in the case of the web server that many users access at the same time, the main controller 201 may operate to use a larger number of processor modules 400 for the web page being accessed or may operate to use web-cashing processor modules connected through high-speed Internet for faster user accessing.

The main controller 201 may receive respective status information from the mounted processor modules 400. Here, the status information of the processor modules 400 may include at least one of a CPU type of the processor module, the number of CPUs, and boot loader information.

On the other hand, the main controller 201 may transmit the received status information to the management server 10. In this case, the management server 10 may display the state of the micro server 200 to the manager or user using the status information of the processor module 400, and may select an appropriate processor module 400 among various types of processor modules to perform resource allocation.

The common interface bus 203 is a connection device connecting the respective configurations of the micro server 200. The respective configurations of the micro server 200 may be connected in parallel to perform bidirectional communication or half duplex communication under the control of the main controller 201. Here, the common interface bus may be a PCI express interface. In this embodiment, only the PCI express interface is used as the common interface bus. However, another interface may be used, or another interface method may be additionally used.

Here, the PCI (Peripheral Component Interconnect) express interface maintains soft-wired compatibility with the PCI parallel interface bus in the related art, and is a local bus standard of an improved serial structure for high-speed input/output between devices. The PCI express interface is suitable to the large-capacity data process. Accordingly, the micro server 200 according to an embodiment of the present disclosure may transfer the data to the respective processor modules 400 through the PCI express interface bus of the common interface bus 203 under the control of the main controller 201.

Specifically, the data that is received from the I/O device 240 may be transmitted to the processor module 400 selected by the switch 300 through the PCI express interface. Here, the switch 300 may select the processor module 400 to which the data is to be transmitted under the control of the main controller 201.

The switch 300 may selectively connect the I/O device 240 and the plurality of processor modules 400 to each other. Specifically, the switch 300 may selectively connect the data received from the I/O device 240 to any one of the plurality of processor modules 400 under the control of the main controller 201 to transmit the data.

Further, the switch 300 may selectively connect the storage system 100 and the plurality of processor modules 400 to each other.

On the other hand, the switch 300 may comprise a PCI express switch circuit (or MRA PCIe switch), and selectively adjust the connection relationship between the plurality of processor modules 400 and at least one I/O card. The switch 300 may implement the I/O virtualization technology.

The switch 300 may adjust the connection structure between the processor modules 400 and the I/O device 240, and may adjust the connection structure between the processor modules 400 and the I/O device 240 without changing the physical position of the processor modules 400.

Further, the switch 300 may adjust the connection structure between the processor modules 400 and the I/O controller 170 of the storage system 100, and may adjust the connection structure between the processor modules 400 and the I/O controller 170 without changing the physical position of the processor modules 400.

The processor modules 400 are connected to the main controller 201 through the common interface bus 203. Specifically, each of the processor modules 400 include a module controller that relays the connection between the common interface bus 203 and the interface that is used by the CPU mounted on the respective processor module 400.

As described above, the processor module 400 refers to a high-density modularized server that can be mounted on the micro server 200. A large number of processor modules can be inserted and installed in a narrow space of the micro server 200, and the processor modules may be provided with core elements of the server, such as one or more CPUs, a storage, and the operating system. The processor modules 400 may receive the power, input/output, and various types of control functions from the micro server 200 to perform the operations as the server.

On the other hand, the micro server 200 according to the present disclosure supports different types of processor modules 400 through the common interface bus 203. The different types of processor modules 400 may be mounted on one micro server 200 to improve utility according to the use purpose of the server.

As an example, if the high-performance micro server 200 is required, a larger number of processor modules 400 having high-performance CPUs mounted thereon can be mounted, while if the low-power micro server 200 is required, a larger number of processor modules 400 having low-power CPUs mounted thereon can be mounted to maximize the utilization according to the user requirements of the server.

Here, the type of the processor module 400 is a type defined according to the type of the CPU mounted on the processor module 400.

As an example, a processor module mounted with the Intel® series CPU may be defined as an Intel type processor module, and a processor module mounted with ARM® series CPU may be defined as an ARM type processor module. In general, the ARM type processor module is specialized in low power, and the Intel type processor module is specialized in high performance. Accordingly, if the user intends to use a high-performance micro server 200, a larger number of Intel type processor modules may be mounted to be used, while if the user intends to use low-power micro server 200, a larger number of ARM type processor modules may be mounted to be used.

Accordingly, the processor module mounted with a high-performance CPU and the processor module mounted with a low-power CPU may be mixedly mounted on one micro server 200 according to the user's selection.

FIG. 16 is a block diagram illustrating the configuration of a processor module 400 in FIG. 15.

Referring to FIG. 16, a processor module 400 according to this exemplary embodiment includes a module controller 410 and a CPU 420. The processor module 400 may be mounted on a base board of the micro server 200.

The module controller 410 is connected to a common interface bus 203 and relays a connection between the common interface bus 203 and the interface used by the CPU 420 of the processor module 400. Specifically, the processor module 400 is designed by an interface that corresponds to the mounted CPU 420. Accordingly, in order to perform communication with the common interface bus of the micro server 200, the module controller 410 may convert the control command and data into an interface protocol that corresponds to the mounted CPU 420.

On the other hand, the module controller 410 may be connected to a BIU (Bus Interface Unit) of the CPU 420 to transmit/receive the control command and data.

As an example, if the type of the CPU that is mounted on the processor module 400 is an Intel® type, the module controller 410 may receive the control command transmitted from the main controller 201 of the micro server 200 through the common interface bus 203, and may convert the transferred control command into the interface having the standard that corresponds to the Intel® type CPU to provide the converted control command to the CPU 420 and the storage 230. Further, the module controller may receive the data transmitted from the I/O device 240 through the common interface bus 203, and may convert the data in the same method as the control command to provide the converted data to the CPU 420.

The CPU 420 is a central processing unit of the processor module 400, and is a device that decodes the control command and executes arithmetic logic operation or data processing. The CPU 420 is provided with BIU (Bus Interface Unit) and thus can perform communication with an external device.

The architecture of the CPU 420 may differ depending on the manufacturer. The architecture refers to the concept that includes even the basic structure, design method, and manufacturing process of the CPU 420, and the clock speed, the number of cores, cache capacity, and BIU are determined. Accordingly, since the interface standards are defined and used according to the architecture of the CPU 420 for each manufacturer, the CPU 420 of another manufacturer is unable to be mixedly used. As an example, a plurality of CPUs may be mounted on one processor module 400. However, since the interface in the processor module 400 is unitedly designed, the plurality of CPUs should be of the same type designed by the same manufacturer. In this case, the plurality of CPUs can execute independent operating systems under the control of one module controller 410.

On the other hand, if the module controller 410 is provided according to the present disclosure, the micro server 200 can be connected to the processor module 400 mounted with the CPU of the different type in the unified interface standard.

FIG. 17 is a flowchart illustrating a method of processing data of a storage system according to an embodiment of the present disclosure.

Referring to FIG. 17, a data request is received from the micro server (operation S1710). Specifically, the transfer of data that is stored in the storage medium in a common interface method may be requested from the micro server.

Then, the storage medium storing the requested data and the interface method of the corresponding storage medium are determined (operation S1720).

Then, the data is requested and received with the determined storage medium and the interface method (operation S1730). At this time, the received data may be temporarily stored in a buffer such as a RAM.

Then, the data received from the storage medium is transmitted to the micro server (operation S1740). Specifically, the data received from the storage medium can be transmitted to the corresponding micro server through the common interface method.

As described above, according to the data processing method described in this embodiment, the communication with the micro server is performed in the common interface method, and thus the communication can be performed without any additional controller (e.g., FC or Ethernet). Further, the storage system 100 is directly connected to a bus in the micro server 200, and thus rapid response becomes possible. The data processing method of FIG. 17 may be executed on the storage system having the configuration of FIG. 5, and may be execute on the storage system having other configurations.

The above-described data processing method may be implemented by a program that can be executed on the computer, and such program may be stored in a non-transitory computer readable medium.

The non-transitory computer readable medium refers to a device-readable medium which does not store data for a short time, such as a register, a cache, and a memory, but semi-permanently stores the data. Specifically, the above-described various applications or programs may be provided and stored in the non-transitory computer readable medium, such as a CD, a DVD, a hard disk, a Blu-ray disk, a USB, a memory card, and a ROM.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A storage system connectable to a plurality of servers including a common interface bus, comprising:
a communicator configured to perform communication with the plurality of servers;
a storage having a plurality of storage media using a preset communication interface; and
an I/O controller configured to transmit and receive data between the plurality of storage media and the plurality of servers in accordance with a mapping table which divides the plurality of storage media into a plurality of regions and stores information of the servers that correspond to the plurality of regions.

2. The storage system as claimed in claim 1, wherein the plurality of storage media are divided into a private region in which an operating system of the specific server is stored and a virtual region which is commonly used by the plurality of servers.

3. The storage system as claimed in claim 1, wherein the I/O controller transmits/receives data with respect to the server through the common interface bus and transmits/receives the transmitted/received data through the communication interface that is used by the storage and the storage media.

4. The storage system as claimed in claim 3, wherein the I/O controller converts a signal that is received through the common interface bus to correspond to the preset communication interface and converts a signal that is received through the storage media to correspond to the common interface bus.

5. The storage system as claimed in claim 3, wherein the common interface bus is a PCI express interface bus.

6. The storage system as claimed in claim 3, wherein the interface bus is at least one of SAS (Serial Attached SCSI), SATA (Serial ATA), and NVMe (Non Volatile Memory express).

7. The storage system as claimed in claim 1, wherein the I/O controller adjusts bandwidths of the servers in accordance with the number of channels of the servers.

8. The storage system as claimed in claim 1, further comprising a switch configured to selectively connect the I/O controller and the plurality of servers to each other.

9. The storage system as claimed in claim 8, wherein the switch comprises a PCI express switch circuit and selectively adjusts a connection relationship between a plurality of processor modules and at least one I/O card.

10. The storage system as claimed in claim 8, wherein the I/O controller adjusts bandwidths between the plurality of servers.

11. The storage system as claimed in claim 1, wherein the I/O controller supports hot swap with respect to the plurality of storage media.

12. The storage system as claimed in claim 1, wherein the I/O controller performs replication of the data and stores replicated data in the plurality of storage media.

13. The storage system as claimed in claim 1, wherein the I/O controller performs de-emphasis process with respect to a signal that is transmitted to the storage medium or the server and performs equalizer process with respect to a signal that is received from the storage medium or the server.

14. The storage system as claimed in claim 1, wherein the storage medium is a HDD (Hard Disk Drive) or a SSD (Solid State Disk).

15. The storage system as claimed in claim 14, wherein the I/O controller makes the plurality of storage media be sequentially driven at an initial driving of the storage system.

16. The storage system as claimed in claim 1, wherein the I/O controller comprises a memory configured to temporarily store data between the server and the storage medium.

17. The storage system as claimed in claim 1, further comprising a BMC (Baseband Management Controller) configured to sense status information of the storage system and to provide an IPMI (Intelligent Platform Management Interface) service so that an external management server can perform remote control of the storage system.

18. The storage system as claimed in claim 17, wherein the BMC controls the I/O controller to allocate a disk to the server if a disk allocation request for the server is received from an external management server.

19. The storage system as claimed in claim 17, wherein the BMC controls the I/O controller to receive management information from the storage media and to perform disk allocation based on the received management information.

20. A server system comprising:
a server including a common interface bus and a plurality of processor modules; and
a storage system including a plurality of storage media and an I/O controller configured to provide data that is stored in the plurality of storage media to the server,
wherein the storage system transmits or receives the data with respect to the server through the common interface bus.
